(19) United States
(12) Patent Application Publication
(10) Pub. No.: US 2026/0260992 A1
(43) Pub. Date: Sep. 3, 2026

(54) STRUCTURAL BATTERY ASSEMBLY

(71) Applicant: Also, Inc., Palo Alto, CA (US)

(72) Inventors: Adam Christopher Bender, San Francisco, CA (US); Ryan James Boris, Pacifica, CA (US); Mark Oliver Dixon Kaufman, San Jose, CA (US); Nicholas Harold Anderson, Santa Cruz, CA (US)

(73) Assignee: Also, Inc., Palo Alto, CA (US)

(21) Appl. No.: 19/554,004

(22) Filed: Mar. 2, 2026

Related U.S. Application Data
(60) Provisional application No. 63/765,884, filed on Mar. 3, 2025.

(51) Int. Cl. H01M 50/242; B62M 6/40; B62M 6/90; H01M 50/213; H01M 50/249

(52) U.S. Cl. CPC H01M 50/242; B62M 6/40; B62M 6/90; H01M 50/213; H01M 50/249; H01M 2220/20

(57) ABSTRACT

A structural battery assembly can include a housing defining a cavity. The housing can include a first battery connector that can form a first structural connection between the housing and a first component of a micromobility device. The structural battery assembly can include a second battery connector that can form a structural connection between the housing and a second component of the micromobility device. The structural battery assembly can include a plurality of battery cells disposed in the cavity. The first battery connector can receive a first force from the first component. The second battery connector can transfer a second force, based at least in part on the first force, to the second component of the micromobility device.

### CROSS-REFERENCE TO RELATED APPLICATIONS

This U.S. Patent Application claims the benefit of and priority to U.S. Provisional Application No. 63/765,884, filed March 3, 2025, the entire disclosure of which is hereby incorporated by reference herein for all purposes.

### BACKGROUND

Bicycles can include an electric motor that receives power from a battery.

### SUMMARY

At least one aspect is directed to a micromobility device. The micromobility device can include a frame. The micromobility device can include a first wheel and a second wheel rotatably coupled with the frame. The micromobility device can include a suspension assembly coupled with the second wheel. The micromobility device can include a drive unit coupled with the suspension assembly by a first suspension connector and by a second suspension connector. The drive unit can receive a pushing force from the suspension assembly via the first suspension connector. The drive unit can receive a pulling force from the suspension assembly via the second suspension connector. The micromobility device can include a structural battery assembly. The structural battery assembly can include a housing defining a cavity. The structural battery assembly can include a plurality of battery cells disposed in the cavity. The structural battery assembly can include a first battery connector coupling the housing with the drive unit. The first battery connector can receive a first pushing force from the drive unit. The structural battery assembly can include a second battery connector coupling the housing with the frame. The second battery connector can receive a second pushing force from the first battery connector induced by the first pushing force. The second pushing force can induce a compression load between the first battery connector and the second battery connector. The structural battery assembly can include a third battery connector coupling the housing with the drive unit. The third battery connector can receive a pulling force from the drive unit. The pulling force can induce a tension load between the second battery connector and the third battery connector. The compression load and the tension load can produce a shear flow transmitted across the housing and around the plurality of battery cells.

At least one aspect is directed to a structural battery assembly. The structural battery assembly can include a housing defining a cavity. The housing can include a first battery connector that can form a first structural connection between the housing and a first component of a micromobility device. The structural battery assembly can include a second battery connector that can form a structural connection between the housing and a second component of the micromobility device. The structural battery assembly can include a plurality of battery cells disposed in the cavity. The first battery connector can receive a first force from the first component. The second battery connector can transfer a second force, based at least in part on the first force, to the second component of the micromobility device.

At least one aspect is directed to a method. The method can include providing a housing defining a cavity. The method can include coupling the housing with a drive unit. The drive unit can receive a pushing force from a suspension assembly of a micromobility device via a first suspension connector. The drive unit can receive a pulling force from the suspension assembly via a second suspension connector. The method can include positioning a plurality of battery cells within the cavity. The method can include coupling the housing with the drive unit by a first battery connector. The first battery connector can receive a first pushing force from the drive unit. The method can include coupling the housing with a frame of the micromobility device by a second battery connector. The second battery connector can receive a second pushing force from the first battery connector induced by the first pushing force. The second pushing force can induce a compression load between the first battery connector and the second battery connector. The method can include coupling the housing with the drive unit by a third battery connector. The third battery connector can receive a pulling force from the drive unit. The pulling force can induce a tension load between the second battery connector and the third battery connector. The compression load and the tension load can produce a shear flow transmitted across the housing and around the plurality of battery cells.

At least one aspect is directed to a method. The method can include providing a micromobility device. The micromobility device can include a frame. The micromobility device can include a first wheel and a second wheel rotatably coupled with the frame. The micromobility device can include a suspension assembly coupled with the second wheel. The micromobility device can include a drive unit coupled with the suspension assembly by a first suspension connector and by a second suspension connector. The drive unit can receive a pushing force from the suspension assembly via the first suspension connector. The drive unit can receive a pulling force from the suspension assembly via the second suspension connector. The micromobility device can include a structural battery assembly. The structural battery assembly can include a housing defining a cavity. The structural battery assembly can include a plurality of battery cells disposed in the cavity. The structural battery assembly can include a first battery connector coupling the housing with the drive unit. The first battery connector can receive a first pushing force from the drive unit. The structural battery assembly can include a second battery connector coupling the housing with the frame. The second battery connector can receive a second pushing force from the first battery connector induced by the first pushing force. The second pushing force can induce a compression load between the first battery connector and the second battery connector. The structural battery assembly can include a third battery connector coupling the housing with the drive unit. The third battery connector can receive a pulling force from the drive unit. The pulling force can induce a tension load between the second battery connector and the third battery connector. The compression load and the tension load can produce a shear flow transmitted across the housing and around the plurality of battery cells.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example micromobility device, in accordance with some aspects.

FIG. 2 depicts a side view of a portion of a micromobility device, in accordance with some aspects.

FIG. 3 depicts a cross-sectional view of an example drive mechanism, in accordance with some aspects.

FIG. 4 depicts a transparent perspective view of an example drive mechanism, in accordance with some aspects.

FIG. 5 depicts an example drive unit and structural battery assembly, in accordance with some aspects.

FIG. 6 depicts an example drive unit and structural battery assembly, in accordance with some aspects.

FIG. 7 depicts an example method of manufacturing or assembling a micromobility device, in accordance with some aspects.

FIG. 8 depicts an example method of providing a micromobility device, in accordance with some aspects.

### DETAILED DESCRIPTION

Following below are more detailed descriptions of various concepts related to, and implementations of, methods, apparatuses, and systems of a structural battery assembly for a micromobility device such as a bike. The various concepts introduced above and discussed in greater detail below may be implemented in any of numerous ways.

This technical solution is generally directed to a structural battery assembly that defines an interior space to store batteries or other energy storage devices (e.g., battery cells, capacitors). The structural battery assembly can facilitate load transfer between components of a micromobility device, such as a bike, without requiring additional structural components. Bikes as described herein can include frame elements or other structures surrounding the energy storage device to facilitate load transfer between components of the bike. The disclosed solutions have a technical advantage of integrating the structural battery assembly with the bike frame, which can reduce an overall weight of the bike by removing redundant structural members. For example, the housing of the structural battery assembly can provide sufficient structure to the frame and load-transferring capabilities such that additional structural components may not be needed.

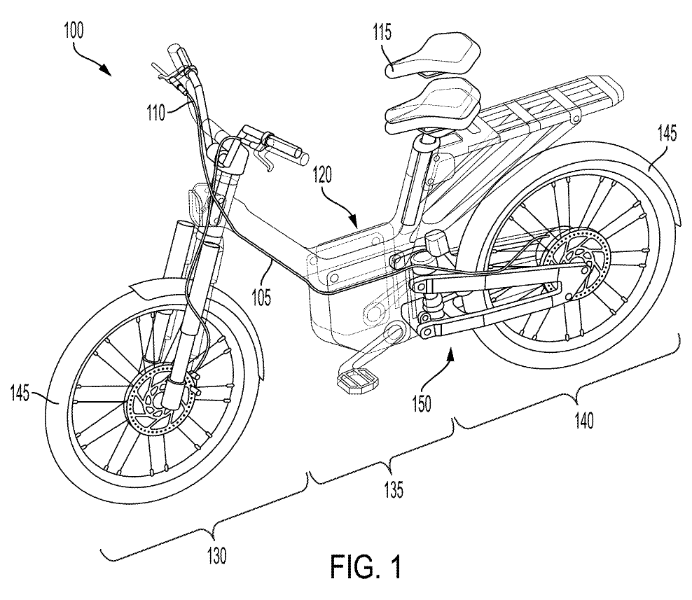

FIG. 1, among others, depicts an example perspective view of a micromobility device 100. The micromobility device 100 can be an electric bike (referred to herein as bike 100, bicycle 100, and similar variations thereof). The bicycle 100 can be a human-operated bike 100. The micromobility device 100 can include single-rider bicycles, tandem bicycles, cargo bicycles, motor-assist bicycles, pedicabs, electric-assist bicycles, ebikes, road bicycles, mountain bicycles, unicycles, segways, or scooters, among others.

The bike 100 can include at least one frame 105 (e.g., chassis). The frame 105 can support various components of the bike 100, such as a handlebar 110, a saddle 115, or a drive mechanism 120 having one or more batteries, motors, and other components, as described herein. The frame 105 can include a front portion 130. The front portion 130 can support, be coupled with, or include, for example, a front wheel 145 of the bike 100, a fork of the bike 100, and the handlebar 110, among other components. The bike 100 can include one or more wheels 145 (e.g., one wheel, two wheels, three wheels, or more wheels). The frame 105 can include a middle portion 135. The middle portion 135 can support, be coupled with, or include, for example, the saddle 115, the drive mechanism 120, a crankshaft of the bike 100, or a pedal of the bike 100, among other components. The frame 105 can include a rear portion 140. The rear portion 140 can support, be coupled with, or include, for example, a rear wheel 145 of the bike 100, a drive train of the bike 100, a suspension assembly 150 of the bike 100, or a rack of the bike 100, among other components.

The bike 100 can be fully electric or partially electric (e.g., pedal-powered), and further, the electric bike 100 can be fully autonomous, partially autonomous, semi-autonomous, or unmanned. The electric bike 100 can also be human-operated or non-autonomous. A human operator or the rider of the bike 100 can sit on a saddle 115 to operate the bike 100. The rider of the bike 100 can steer, grip, balance, or otherwise control the bike 100 using the handlebar 110.

The bike 100 can include at least one battery pack (e.g., one or more packs holding one or more battery cells), described herein, which can include batteries, battery modules, or battery cells that can power the electric bike 100. The battery pack(s) can be installed or placed within the bike 100. For example, the one or more batteries can be installed on the frame 105 of the bike 100 within one or more of the front portion 130, the middle portion 135, or the rear portion 140, or within a portion of the drive mechanism 120. The batteries can include or connect with at least one busbar, e.g., a current collector element. For example, the busbar can include electrically conductive material to connect or otherwise electrically couple the battery with other electrical components of the bike 100 to provide electrical power to various systems or components of the bike 100.

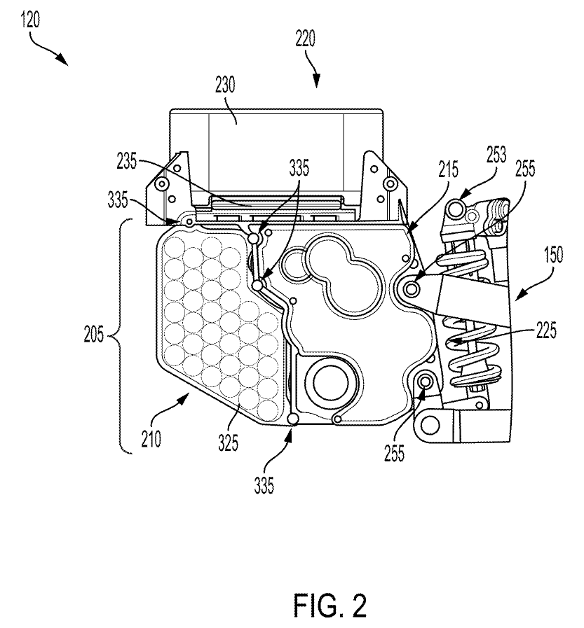

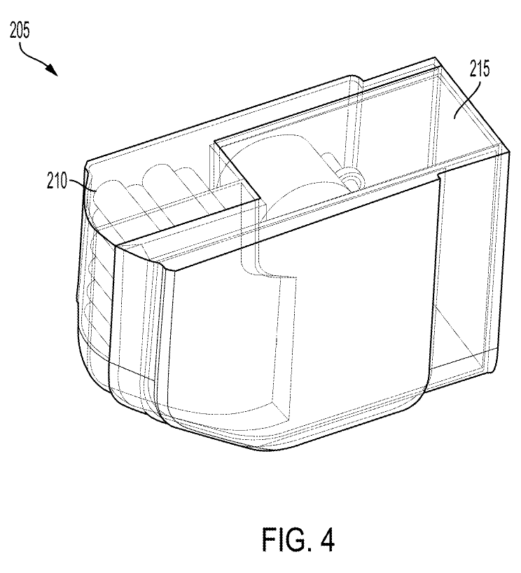

As shown in FIGS. 2-4, among others, the drive mechanism 120 can include at least one enclosure 205. The enclosure 205 can define a space for various components of the bike 100 to be stored. For example, the enclosure 205 can store a structural battery assembly 210 (e.g., a primary battery), a motor 345, and at least one gear 340. The enclosure 205 can include one or more walls or surfaces that extend around an area to define the space. The enclosure 205 can at least partially or entirely enclose the space, including components stored within the space (e.g., such that components in the enclosure 205 are not exposed to the outside of the enclosure 205). The enclosure 205 can define one monolithic space, or the enclosure 205 can include a plurality of walls, surfaces, or other features that define multiple spaces.

The enclosure 205 can couple with a suspension assembly 150 at a first portion of the enclosure 205. The enclosure 205 can couple with the frame 105 of the bike 100 at a second portion of the enclosure 205. For example, the enclosure 205 can couple with the frame 105 at a top portion 220 of the enclosure 205 (e.g., by one or more fasteners, welding, etc.) and at an underside of the frame 105 (e.g., a portion of the frame closest to the ground, opposite the saddle 115) along the middle portion 135 of the bike 100, as depicted in at least FIGS. 1-2. The enclosure 205 can couple with the suspension assembly 150 at a side portion 225 of the enclosure 205 at or near the rear portion 140 of the bike 100. The enclosure 205 can include at least one structural battery assembly 210 and at least one drive unit 215. The structural battery assembly 210 can be configured or shaped to correspond to a shape of the drive unit 215. The structural battery assembly 210 can couple with the drive unit 215.

The drive mechanism 120 can include at least one energy storage device in addition to the structural battery assembly 210. For example, the drive mechanism can include at least one external battery 230. The external battery 230 can be independent from and in addition to an energy storage device stored in the structural battery assembly 210. The external battery 230 can removably couple with a portion of the bike 100, such as the enclosure 205, the frame 105, or another portion of the bike 100. The external battery 230 can couple with the enclosure 205 at a top portion 220 of the enclosure 205 or at another portion of the enclosure 205. For example, the external battery 230 can couple with the frame 105 at the middle portion 135 of the bike 100 (e.g., on top of the enclosure 205 or coupled with the frame 105 at a position above the enclosure 205) or at the front portion 130 of the bike 100 (e.g., coupled with the frame 105 at a position forward of the enclosure 205). The external battery 230 can be removably attached to the bike 100 in various ways, including, but not limited to, fasteners, clamps, snaps, harnesses, or other components. The external battery 230 can electrically connect to one or more components stored within the enclosure 205 in various ways, such as through a busbar.

The external battery 230 can be removable such that a user of the bike 100 can remove the external battery 230 or attach the external battery 230 as an additional power supply for the bike 100. The battery 230 can be removable and couplable with various parts of the bike 100 (e.g., along the frame 105) for aesthetic purposes or various other purposes. For example, the bike 100 can include a plurality of electrical attachments (e.g., busbars, harness, etc.) to receive the secondary battery 230 at various locations along the bike 100.

The drive mechanism can include at least one bike lock 235. The bike lock 235 can be coupled with the bike 100. For example, the bike lock 235 can couple with the enclosure 205. The bike lock 235 can include at least one portion that extends out beyond the enclosure 205 and can receive a post, fence, or other fixture to lock the bike 100 with the fixture. For example, at least a portion of the bike lock 235 can separate and removably couple with another portion of the bike lock 235 such that the bike lock 235 can be uncoupled, attached to a fixture, and recoupled. The bike lock 235 can include one or more electrical connections, sensors, or other components to facilitate electrically coupling and decoupling with the bike 100.

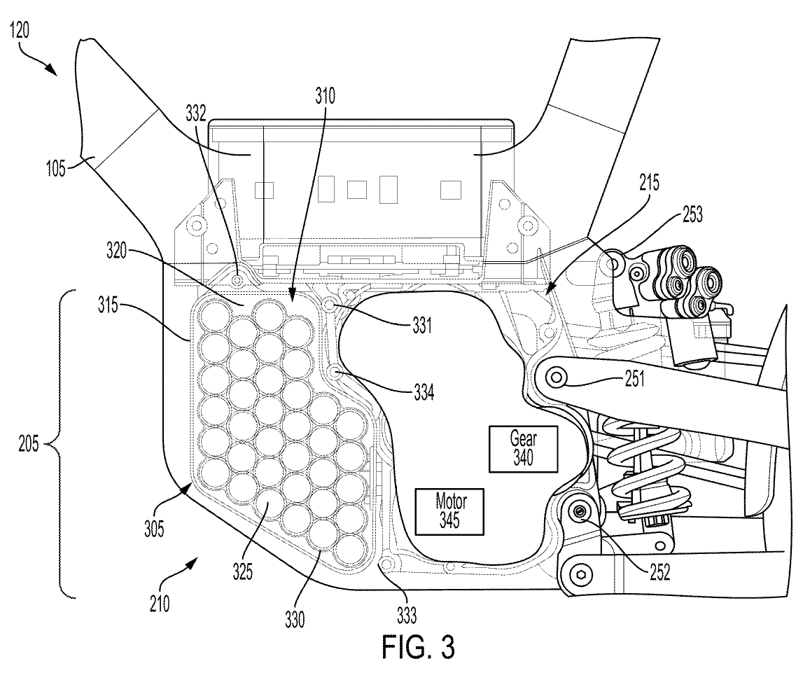

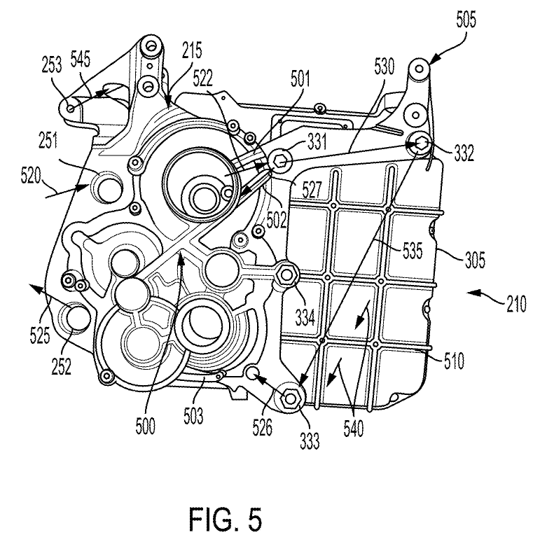

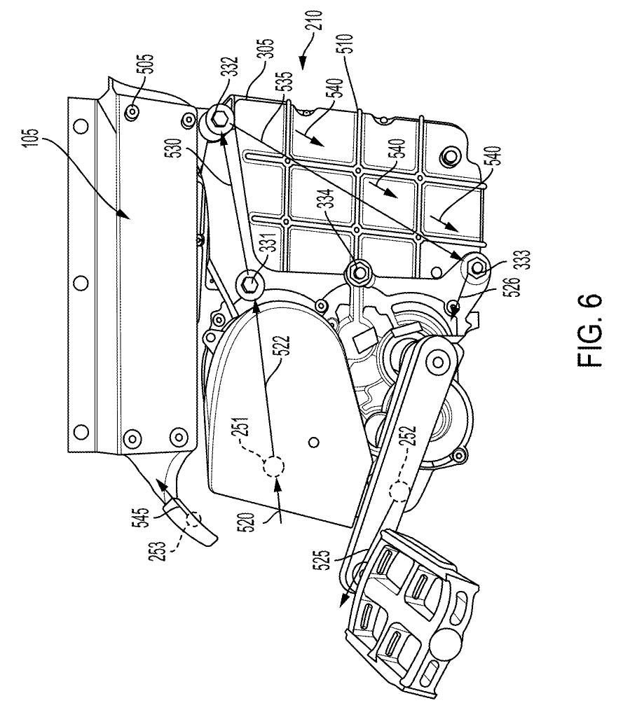

As shown in FIGS. 3-6, among others, the drive mechanism 120 can include the structural battery assembly 210 and the drive unit 215. The structural battery assembly 210 can provide structural support to the bike 100 and facilitate load transfer between components of the bike 100. For example, the structural battery assembly 210 can facilitate load transfer between a first component, such as the suspension assembly 150, and a second component, such as drive unit 215. The structural battery assembly 210 can include at least one housing 305. The housing 305 can define a cavity 310 to store other components of the structural battery assembly 210. The housing 305 can structurally support the bike 100. For example, the housing 305 can replace a structural frame member of the bike 100. The structural battery assembly 210 can include at least one energy storage device, shown as battery cell 325. The structural battery assembly 210 can include any form of energy storage device (e.g., battery, battery pack). The structural battery assembly 210 can include a plurality of battery cells 325. For example, a plurality of battery cells 325 can be disposed in the cavity 310 of the housing 305. The battery cells 325 can have any shape or form factor (e.g., cylindrical, rectangular).

The housing 305 can include at least one perimeter panel 315. The perimeter panel 315 can define a shape of the housing 305. The housing 305 can have any shape. For example, the shape of the housing 305 can be based on a location on the bike 100 that the structural battery assembly 210 is to be disposed of. For example, the shape of the housing 305 can be structured to fit within the drive mechanism 120, such that the housing 305 at least partially abuts a drive unit 215 of the bike 100. The perimeter panel 315 can define a width of the housing 305. The perimeter panel 315 can be sized based on the length of the battery cells 325 the housing 305 will house, such that the length of the battery cells 325 can extend along the perimeter panel 315.

The housing 305 can include at least one side panel 320. The side panel 320 can couple with the perimeter panel 315. The housing 305 can have a plurality of side panels 320. For example, a first side panel 320 can couple with a first side of the perimeter panel 315, and a second side panel 320 can couple with a second side of the perimeter panel 315. The perimeter panel 315 and the side panels 320, or the plurality of side panels 320, can define the cavity 310. The side panel 320 can be a load-bearing or load-transferring plate (e.g., a shear plate). For example, a load applied to the bike 100 can transfer between components via the side panel 320. At least one of the side panel 320 or the perimeter panel 315 can include at least one rib 510. The rib 510 can extend away from an outer surface of the side panel 320 or the perimeter panel 315. The rib 510 can extend away from an inner surface of the side panel 320 or the perimeter panel 315. The housing 305 can include a plurality of ribs 510. For example, the housing 305 can include a plurality of ribs 510 that intersect with one another to form a grid or waffle pattern. The ribs 510 can function to reinforce the panels 315, 320 and to receive load applied to the structural battery assembly 210. For example, the housing 305 having ribs 510 can have a larger bending stiffness and shear stiffness relative to a housing 305 without ribs 510.

The perimeter panel 315 and the side panel 320 can be any material. For example, the perimeter panel 315 and the side panel 320 can be a thermally conductive material such as aluminum or an aluminum alloy. The perimeter panel 315 and the side panel 320 can be made of a material less thermally conductive than aluminum, such as plastic. The perimeter panel 315 and the side panel 320 can be the same material or different materials. The material can have sufficient structural strength and stiffness to provide the necessary load-bearing capacity for the bike 100 such that no additional frame support is needed where the structural battery assembly 210 is positioned. The thermally conductive perimeter panel 315 or thermally conductive side panel 320 can act as a heat sink to absorb heat generated within the structural battery assembly 210 and dissipate it away from the plurality of battery cells 325 to the external environment. For example, at least one of the perimeter panel 315 or the side panel 320 can transfer heat from the interior of the housing 305 to ambient air or to adjacent components that are configured for thermal dissipation, such as cooling fins or external surfaces exposed to airflow, among others. One or more devices structured for thermal dissipation, such as cooling fins, can be positioned between the housing 305 and the enclosure 205. The enclosure 205 can include perforations, openings, or other venting to assist with dissipating heat generated by the battery cells 325.

The structural battery assembly 210 can include at least one battery positioning device, shown as battery holder 330. The battery holder 330 can be disposed of within the cavity 310. The battery holder 330 can position the battery cells 325 within the cavity 310. For example, the battery holder 330 can hold a plurality of battery cells 325. The battery holder 330 can couple with the housing 305 at least one location to maintain a position of the battery holder 330, and therefore a position of the battery cells 325, relative to the housing 305. For example, the battery holder 330 can couple with the perimeter panel 315 at least one location. The battery holder 330 can include openings to receive the battery cells 325. For example, the openings can extend between a first side panel 320 and a second side panel 320, such that the battery cells 325 extend between the first side panel 320 and the second side panel 320. In this way, when the bike 100 is in an upright position (e.g., as shown in FIG. 1) the battery cells 325 are positioned horizontally within the housing 305 of the structural battery assembly 210. For example, while the bike 100 is in the upright position, the battery cells 325 are positioned such that a central longitudinal axis of the battery cells 325 is parallel to, or substantially parallel to, a ground plane.

The battery cell 325 can be spaced away from the perimeter panel 315. For example, the battery holder 330 can position the battery cells 325 away from an inner surface of the perimeter panel 315. An outer surface of the battery holder 330 can be positioned away from the inner surface of the perimeter panel 315. A gap can be defined between the inner surface of the perimeter panel 315 and an outer surface of the battery holder 330. A substance (e.g., potting) can fill the gap between the perimeter panel 315 and the battery holder 330. The space between the battery cell 325 and the perimeter panel 315 can prevent the perimeter panel 315 from contacting the battery cells 325 or reduce the force applied to the battery cells 325 from the perimeter panel 315 when the perimeter panel 315 flexes due to a force applied to the bike 100.

The structural battery assembly 210 can include at least one battery connector 335. The structural battery assembly 210 can couple with the bike 100, or components thereof, via the battery connector 335. The structural battery assembly 210 can include a plurality of battery connectors 335. For example, the structural battery assembly 210 can include a first battery connector 331 that couples the housing 305 of the structural battery assembly 210 with the drive unit 215. The structural battery assembly 210 can include a second battery connector 332 that couples the housing 305 of the structural battery assembly 210 with the frame 105 directly, or via an intervening frame connector. The structural battery assembly 210 can include a third battery connector 333 coupling the housing 305 of the structural battery assembly 210 with the drive unit 215. The structural battery assembly 210 can have a fourth battery connector 334 coupling the housing 305 of the structural battery assembly 210 with the drive unit 215. Each battery connector 335 can be or include a fastener that extends through the housing 305 and a corresponding opening in the drive unit 215, in the frame 105, in the enclosure 205, or in an intervening frame connector, among others.

The housing 305 can include a first battery connector 331. The first battery connector 331 can form a structural connection between the housing 305 of the structural battery assembly 210 and a first component of the bike 100. For example. The first battery connector 331 can form a structural connection between the housing 305 of the structural battery assembly 210 and the drive unit 215. The housing 305 can include a second battery connector 332. The second battery connector 332 can form a structural connection between the housing 305 of the structural battery assembly 210 and a second component of the bike 100. For example, the second battery connector 332 can form a structural connection between the housing 305 of the structural battery assembly 210 and the frame 105. The structural battery assembly 210 can be the sole connecting element between the first component and the second component of the bike 100. The structural battery assembly 210 can receive and transmit forces between the first component and the second component. For example, the first battery connector 331 can receive a first force from the first component. The second battery connector 332 can transfer a second force, which is based at least in part on the first force, to the second component. For example, the bike 100 can be formed by connecting the first component to the housing 305 of the structural battery assembly 210 and by connecting the second component to the housing 305 of the structural battery assembly 210. In examples, the only structural connection between the first component and the second component can be formed by the structural battery assembly 210.

The drive unit 215 can include at least one component connector 255. The component connector 255, also referred to herein as the suspension connector 255, can couple the drive unit 215 with the suspension assembly 150. The suspension assembly 150 can experience external forces by the wheel 145, such as road irregularities or bumps, gravity induced by rider weight, braking, or acceleration, among others. The external forces on the suspension assembly 150 can define a load path through the drive unit 215, the structural battery assembly 210, or the frame 105, among others. The drive unit 215 can include a first suspension connector 251 that couples the drive unit 215 with a first portion of the suspension assembly 150, such as a fork of the suspension assembly 150. For example, the suspension assembly 150 can generate a pushing force of The compression load 530 can be approximately 6-14 kilonewtons (kN), 8-12 kN, or greater than 12 kN. The first suspension connector 251 can receive a pushing force 520 from the suspension assembly 150. Such a pushing force can induce a compression load within the drive unit 215. The drive unit 215 can include a second suspension connector 252 that couples the drive unit 215 with a second portion of the suspension assembly 150, such as a fork of the suspension assembly 150. The second suspension connector 252 can receive a pulling force 525 from the suspension assembly 150. Such a pulling force 525 can induce a tension load on the drive unit 215. The drive unit 215 can include a third suspension connector 253 that couples the drive unit 215 with a third portion of the suspension assembly 150, such as a shock. The third suspension connector 253 can receive a pushing force 545 from the shock of the suspension assembly 150. The third suspension connector 253 can direct such a pushing force to the frame 105, or to some other component of the bike 100.

The first battery connector 331 can receive a first pushing force 522 from the drive unit 215. The first pushing force 522 transferred from the drive unit 215 to the first battery connector 331 can be based at least in part on the pushing force 520 of the suspension assembly 150 received by the drive unit 215. The second battery connector 332 can receive a second pushing force from the first battery connector 331. The second pushing force can be induced by the first pushing force 522. The second pushing force can induce a compression load 530 between the first battery connector 331 and the second battery connector 332. The compression load 530 introduces stress on a top portion (e.g., the portion nearest the frame 105) of the housing 305 of the structural battery assembly 210.

The third battery connector 333 can receive a pulling force 526 (e.g., a third force) from the drive unit 215. The pulling force 526 can be based at least in part on the pulling force 525 of the suspension assembly 150 received by the drive unit 215. The pulling force 526 can induce a tension load 535 between the second battery connector 332 and the third battery connector 333. Such a tension load 535 can introduce tensile stress on a bottom portion of the housing 305 of the structural battery assembly 210. The compression load 530 acting between the first battery connector 331 and the second battery connector 332 and the tension load 535 acting between the second battery connector 332 and the third battery connector 333 can occur simultaneously. Because these segments of the housing 305 are connected by the side panels 320 of the housing 305, the difference in axial loading between the compression load 530 and the tension load 535 produces tangential shear forces, shown as shear flow 540, in the side panels 320 of the housing 305. The shear flow 540 can be transmitted continuously across the side panels 320 and around the plurality of battery cells 325 held within the cavity 310 and the battery holder 330. For example, the shear flow 540 can bypass the plurality of battery cells 325 by traveling through the side panels 320 and ribs 510 of the housing 305. In some embodiments, at least a portion, a majority, at least about 80%, at least 90%, or more of the shear flow 540 can bypass the battery cells 325.

The ribs 510 can be integrally formed with the side panels 320 and can extend from the inner and/or outer surfaces of the side panels 320. The ribs 510 can intersect to form a grid or waffle pattern, subdividing each panel into smaller sections. This subdivision increases the shear stiffness of the housing 305 by reducing the unsupported span of the side panel 320. The ribs 510 can further mitigate or prevent local buckling of the side panel 320 under the compression load 530.

The drive unit 215 can include at least one rib 500. The ribs 500 can be integral with the drive unit 215. For example, the drive unit 215 and the ribs 500 can be molded together in a single material. The drive unit 215 and the ribs 500 can be made of different materials. The ribs 500 are shown to extend away from a surface of the drive unit 215. The ribs 500 can define a uniform thickness along their length or a variable thickness along their length. The ribs 500 can define a uniform height along their length or a variable height along their length. In this way, the cross-section of the ribs 500 may be uniform or variable along the length of the ribs 500. For example, the ends of the ribs 500 can have a larger cross-section than the cross-section of a portion of the ribs 500 extending between the ends.

For example, the drive unit 215 can include a first rib 501 that extends between the first suspension connector 251 and the first battery connector 331. The first rib 501 can include straight portions and curved portions. For example, a portion of the first rib 501 can curve to extend around components of the drive unit 215. For example, the drive unit 215 can include a bearing configured to couple with one or more mechanical drive elements, such as a pulley, sprocket, and chain. The first rib 501 can curve around an edge of the bearing. The first rib 501 can direct at least a portion of the first pushing force 522 from drive unit 215 to the first battery connector 331. For example, the first rib 501 can direct at least a portion of the first pushing force 522 to the first battery connector 331 to induce the compression load 530 in the structural battery assembly 210. For example, the first rib 501 of the drive unit 215 can direct 20-50%, 50-70%, 70-90%, or greater than 90% of the pushing force 522 to the first battery connector 331. For example, at least a portion of the compression load 530 can be induced by direction of the first pushing force 522 to the first battery connector 331 by the first rib 501.

The drive unit 215 can include a second rib 502 that extends between the second suspension connector 252 and the first battery connector 331. The second rib 502 can include straight portions and curved portions. For example, a portion of the second rib 502 can curve to extend around components of the drive unit 215, such as a bearing, housing boss, or other support feature within the drive unit 215. The second rib 502 can direct at least a portion of a pulling force 527 (e.g., a fourth force) from the drive unit 215 to the first battery connector 331. The pulling force 527 can be induced by the pulling force 525 of the suspension assembly 150 on the drive unit 215. For example, the second rib 502 can direct at least a portion of the pulling force 527 to the first battery connector 331. The second rib 502 can carry an alternative or secondary load path for the pulling force 525 in combination with other structural elements, without directly inducing the primary tension load 535 across the battery housing between the second battery connector 332 and the third battery connector 333. For example, the second rib 502 of the drive unit 215 can direct 20-50%, 50-70%, 70-90%, or greater than 90% of the pulling force 527 to the first battery connector 331.

The drive unit 215 can include a third rib 503 that extends between the third battery connector 333 and the second suspension connector 252. The third rib 503 can include straight portions and curved portions. For example, a portion of the third rib 503 can curve to extend around components of the drive unit 215. For example, the drive unit 215 can include a bearing or opening configured to couple with one or more mechanical drive elements, such as a shaft of a pedal assembly. The third rib 503 can curve around an edge of the opening, such that the third rib 503 curves above or below the shaft of the pedal assembly. The third rib 503 can transmit at least a portion of the pulling force 526 from the drive unit 215 to the third battery connector 333. Transmission of this pulling force 526 through the third rib 503 to the third battery connector 333 can induce the tension load 535 across the battery housing 305 between the second battery connector 332 and the third battery connector 333. This tension load 535 can act in parallel with the compression load 530 between the first battery connector 331 and the second battery connector 332, generating the shear flow 540 in the housing 305 and the ribs 510 of the structural battery assembly 210. The third rib 503 can direct approximately 20–50%, 50–70%, 70–90%, or greater than 90% of the pulling force 526 to the third battery connector 333.

The fourth battery connector 334 can be positioned between the first battery connector 331 and the third battery connector 333. The fourth battery connector 334 can couple the housing 305 of the structural battery assembly 210 with the drive unit 215. The fourth battery connector 334 can be structured for noise, vibration, and harshness (NVH) control rather than, or in addition to, structural load transfer. The fourth battery connector 334 can provide an intermediate anchoring point to the housing 305, thereby reducing resonance amplification of drive unit 215 vibrations during operation of the bike 100. The fourth battery connector 334 can locally increase mounting stiffness. The fourth battery connector 334 can include a damping element, such as an elastomeric bushing. The fourth battery connector 334 can attenuate vibration amplitude in the housing 305, reduce radiated noise, and diminish perceived harshness.

The structural battery assembly 210 and the drive unit 215 can be a single unit or housing. For example, the perimeter panel 315 and the side panel 320 can extend around the drive unit 215 such that the cavity 310 receives the drive unit 215. For example, the perimeter panel 315 can extend around a plurality of battery cells 325 and any gears 340 or motors 345 or other components that are housed in a drive unit 215 such that the battery cells 325, gears 340, and/or motors are disposed in the cavity 310. The structural battery assembly 210 and the drive unit 215 can couple with the frame 105 of the vehicle by one or more frame connectors 505. For example, the structural battery assembly 210 and the drive unit 215 can be mounted to the frame 105 of the bike 100 by positioning fasteners through the one or more frame connectors 505 to couple the frame 105 with the structural battery assembly 210 and the drive unit 215. For example, the frame connectors 505 can couple the drive unit 215 and the structural battery assembly 210 with the frame 105 of the middle portion 135 of the bike 100. Positioning the structural battery assembly 210 and the drive unit 215 in the middle portion 135 of the bike 100 situates these components near the center of gravity of the bike 100, which can reduce an effect of their weight on steering performance. In other embodiments, the frame connectors 505 can couple the drive unit 215 and the structural battery assembly 210 to the frame 105 in the front portion 130, the rear portion 140, or in other suitable locations.

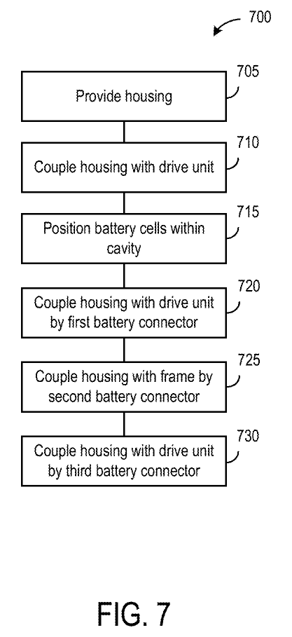

FIG. 7 is a flow diagram of an example method 700 of assembling or otherwise manufacturing the structural battery assembly 210. The method 700 can include at least one act of providing a housing 305 of the structural battery assembly 210 (e.g., act 705). The housing 305 can include one or more perimeter panels 315 extending between a first side panel 320 and a second side panel 320 to define a cavity 310. The housing 305 can include at least one rib 510 extending from the housing 305. For example, the side panels 320 can include a plurality of intersecting ribs 510. The method 700 can include at least one act of coupling the housing 305 of the structural battery assembly 210 with the drive unit 215 (e.g., act 710). The drive unit 215 can receive a pushing force 520 from a suspension assembly 150 of a micromobility device 100. For example, the drive unit 215 can receive the pushing force 520 via a first suspension connector 251 coupling the drive unit 215 with the suspension assembly 150. The drive unit 215 can receive a pulling force 525 from the suspension assembly 150. For example, the drive unit 215 can receive the pulling force 525 via a second suspension connector 252 coupling the drive unit 215 with the suspension assembly 150.

The method 700 can include at least one act of positioning a plurality of battery cells 325 within the cavity 310 of the structural battery assembly 210 (e.g., act 715). For example, the structural battery assembly 210 can include a battery holder 330 that can receive the battery cells 325. The battery holder 330 can be disposed within the cavity 310. The battery holder 330 can couple with the housing 305 at least one location to maintain a position of the battery holder 330, and therefore a position of the battery cells 325, relative to the housing 305. For example, the battery holder 330 can couple with the perimeter panel 315 at least one location. The battery cell 325 can be spaced away from the perimeter panel 315. For example, the battery holder 330 can position the battery cells 325 away from an inner surface of the perimeter panel 315. An outer surface of the battery holder 330 can be positioned away from the inner surface of the perimeter panel 315. A gap can be defined between the inner surface of the perimeter panel 315 and an outer surface of the battery holder 330. The battery cell 325 can be spaced away from the side panel 320. For example, the battery holder 330 can position the battery cells 325 away from an inner surface of the side panel 320. An outer surface of the battery holder 330 can be positioned away from the inner surface of the side panel 320. A gap can be defined between the inner surface of the side panel 320 and an outer surface of the battery holder 330. In this way, the battery cells 325 are spaced apart from the shear flow 540 forces carried through the side panels 320 of the housing 305. By positioning the battery cells 325 away from the perimeter panels 315 and the side panel 320, the battery cells 325 can be isolated from direct mechanical stress and vibration. This arrangement can protect the battery cells 325 from mechanical stress while allowing the housing 305 to carry compression load 530, tension load 535, and shear flow 540 forces. Beneficially, such an arrangement can allow the structural battery assembly 210 to replace elements of the frame 105 that would otherwise be included to carry the compression load 530, the tension load 535, and the shear flow 540 forces. This can reduce the weight of the bike 100 and the cost of providing the bike 100.

The method 700 can include at least one act of coupling the housing 305 with the drive unit 215 by a first battery connector 331 (e.g., act 720). The first battery connector 331 can receive the pushing force 520 from the drive unit 215. The method 700 can include at least one act of coupling the housing 305 of the structural battery assembly 210 with a frame 105 of the micromobility device 100 by a second battery connector 332 (e.g., act 725). The second battery connector 332 can receive the pushing force 520 from the first battery connector 331. The pushing force 520 can induce a compression load 530 between the first battery connector 331 and the second battery connector 332. The compression load 530 introduces stress on a top portion (e.g., the portion nearest the frame 105) of the housing 305 of the structural battery assembly 210.

The method 700 can include at least one act of coupling the housing 305 of the structural battery assembly 210 with the drive unit 215 by a third battery connector 333 (e.g., act 730). The third battery connector 333 can receive the pulling force 525 from the drive unit 215. The pulling force 525 can incudes a tension load 535 between the second battery connector 332 and the third battery connector 333. The compression load 530 and the tension load 535 can produce a shear flow 540 transmitted across the housing 305 and around the plurality of battery cell 325. The shear flow 540 can be transmitted continuously across side panels 320 of the housing 305 and around the plurality of battery cells 325 held within the cavity 310 and the battery holder 330. For example, the shear flow 540 can bypass the plurality of battery cells 325 by travelling through the side panels 320 and ribs 510 of the housing 305. In some embodiments, at least a portion, a majority, at least about 80%, at least 90%, or more of the shear flow 540 can bypass the battery cells 325, distributing load circumferentially and maintaining the structural load path between the suspension assembly 150 and the frame 105.

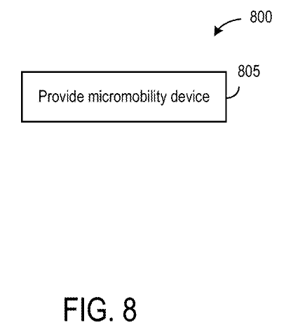

FIG. 8 is a flow diagram of an example method 800. The method can include at least one act of providing a micromobility device 100 (e.g., act 805). The micromobility device can include a frame 105. The micromobility device can include a first wheel 145 and a second wheel 145 rotatably coupled with the frame 105. The micromobility device 100 can include a suspension assembly 150 coupled with the first wheel 145 or the second wheel 145. The micromobility device 100 can include a drive unit 215 coupled with the suspension assembly 150 by a first suspension connector 251 and by a second suspension connector 252. The drive unit 215 can receive a pushing force 520 from the suspension assembly 150 via the first suspension connector 251.

The drive unit 215 can receive a pulling force 525 from the suspension assembly 150 via the second suspension connector 252. The micromobility device 100 can include a structural battery assembly 210. The structural battery assembly 210 can include a housing 305 defining a cavity 310. The structural battery assembly can include a plurality of battery cells 325 disposed in the cavity 310. The structural battery assembly 210 can include a first battery connector 331 coupling the housing 305 with the drive unit 215. The first battery connector 331 can receive a first pushing force 522 from the drive unit 215. The structural battery assembly 210 can include a second battery connector 332 coupling the housing 305 with the frame 105. The second battery connector 332 can receive a second pushing force, induced by the first pushing force 522, from the first battery connector 331. The second pushing force can induce a compression load 530 between the first battery connector 331 and the second battery connector 332. The structural battery assembly 210 can include a third battery connector 333 coupling the housing 305 with the drive unit 215. The third battery connector 333 can receive pulling force 525 from the drive unit 215. The pulling force 525 can induce a tension load 535 between the second battery connector 332 and the third battery connector 333. The compression load 530 and the tension load 535 can produce a shear flow 540 transmitted across the housing 305 and around the plurality of battery cells 325.

At least one aspect is directed to a micromobility device. The micromobility device can include a frame. The micromobility device can include a first wheel and a second wheel rotatably coupled with the frame. The micromobility device can include a suspension assembly coupled with the second wheel. The micromobility device can include a drive unit coupled with the suspension assembly by a first suspension connector and by a second suspension connector. The drive unit can receive a pushing force from the suspension assembly via the first suspension connector. The drive unit can receive a pulling force from the suspension assembly via the second suspension connector. The micromobility device can include a structural battery assembly. The structural battery assembly can include a housing defining a cavity. The housing can include a plurality of intersecting ribs forming a grid structure on an exterior surface of the housing. The structural battery assembly can include a plurality of battery cells disposed in the cavity. The structural battery assembly can include a first battery connector coupling the housing with the drive unit. The first battery connector can receive a first pushing force from the drive unit. The structural battery assembly can include a second battery connector coupling the housing with the frame. The second battery connector can receive a second pushing force from the first battery connector induced by the first pushing force. The second pushing force can induce a compression load between the first battery connector and the second battery connector. The structural battery assembly can include a third battery connector coupling the housing with the drive unit. The third battery connector can receive pulling force from the drive unit. The pulling force can induce a tension load between the second battery connector and the third battery connector. The compression load and the tension load can produce a shear flow transmitted across the housing and around the plurality of battery cells. The plurality of intersecting ribs being can reinforce the walls of the housing and transmit the shear flow around the plurality of battery cells.

The drive unit can include a first rib extending between the first suspension connector and the first battery connector. The first rib can direct at least a portion of the pushing force from the first suspension connector to the first battery connector. The drive unit can include a second rib extending between the second suspension connector and the first battery connector. The second rib can direct at least a portion of the pulling force from the second suspension connector to the first battery connector. The drive unit can include a third rib extending between the second suspension connector and the third battery connector. The third rib can direct at least a portion of the pulling force from the second suspension connector to the third battery connector.

At least one aspect is directed to a micromobility device. The micromobility device can include a frame. The micromobility device can include a first wheel and a second wheel rotatably coupled with the frame. The micromobility device can include a suspension assembly coupled with the second wheel. The micromobility device can include a drive unit coupled with the suspension assembly by a first suspension connector and by a second suspension connector. The drive unit can receive a pushing force from the suspension assembly via the first suspension connector. The drive unit can receive a pulling force from the suspension assembly via the second suspension connector. The micromobility device can include a structural battery assembly. The structural battery assembly can include a housing defining a cavity. The structural battery assembly can include a plurality of battery cells disposed in the cavity. The structural battery assembly can include a battery holder disposed in the cavity. The battery holder can hold the plurality of battery cells, such that the plurality of battery cells are spaced away from an inner surface of the housing. The structural battery assembly can include a first battery connector coupling the housing with the drive unit. The first battery connector can receive a first pushing force from the drive unit. The structural battery assembly can include a second battery connector coupling the housing with the frame. The second battery connector can receive a second pushing force from the first battery connector induced by the first pushing force. The second pushing force can induce a compression load between the first battery connector and the second battery connector. The structural battery assembly can include a third battery connector coupling the housing with the drive unit. The third battery connector can receive pulling force from the drive unit. The pulling force can induce a tension load between the second battery connector and the third battery connector. The compression load and the tension load can produce a shear flow transmitted across the housing and around the plurality of battery cells. The structural battery assembly can include a fourth battery connector coupling the housing with the drive unit. The fourth battery connector can be positioned between the first battery connector and the third battery connector and can dampen vibrations transmitted from the drive unit to the housing.

At least one aspect is directed to a structural battery assembly. The structural battery assembly can include a housing defining a cavity. The housing can include a first battery connector that can form a first structural connection between the housing and a first component of a micromobility device. The structural battery assembly can include a second battery connector that can form a structural connection between the housing and a second component of the micromobility device. The structural battery assembly can include a plurality of battery cells disposed in the cavity. The first battery connector can receive a first force from the first component. The second battery connector can transfer a second force, based at least in part on the first force, to the second component of the micromobility device.

The first force can induce a compression load between the first battery connector and the second battery connector. The structural battery assembly can include a third battery connector configured to form a second structural connection between the housing and the first component of the micromobility device. The third battery connector can receive a third force from the first component. The third force can induce a tension load between the second battery connector and the third battery connector. The compression load and the tension load can produce a shear flow transmitted across the housing and around the plurality of battery cells. The housing can include a plurality of intersecting ribs forming a grid structure on an exterior surface of the housing, the plurality of intersecting ribs being configured to reinforce walls of the housing and to transmit the shear flow around the plurality of battery cells.

At least one aspect is directed to a structural battery assembly. The structural battery assembly can include a housing defining a cavity. The housing can include a first battery connector that can form a first structural connection between the housing and a first component of a micromobility device. The structural battery assembly can include a second battery connector that can form a structural connection between the housing and a second component of the micromobility device. The structural battery assembly can include a plurality of battery cells disposed in the cavity. The first battery connector can receive a first force from the first component. The second battery connector can transfer a second force, based at least in part on the first force, to the second component of the micromobility device. The structural battery assembly can include a third battery connector configured to form a second structural connection between the housing and the first component of the micromobility device, wherein the third battery connector is configured to receive a third force from the first component.

The first component can include a first rib extending between a first suspension connector and the first battery connector, the first rib configured to direct at least a portion of the first force to the first battery connector. The first component can include a second rib extending between a second component connector and the first battery connector. The second rib can direct at least a portion of a fourth force to the first battery connector. The first component can include a third rib extending between a second component connector and the third battery connector. The third rib can direct at least a portion of the third force to the third battery connector.

At least one aspect is directed to a structural battery assembly. The structural battery assembly can include a housing defining a cavity. The housing can include a first battery connector that can form a first structural connection between the housing and a first component of a micromobility device. The structural battery assembly can include a second battery connector that can form a structural connection between the housing and a second component of the micromobility device. The structural battery assembly can include a plurality of battery cells disposed in the cavity. The structural battery assembly can include a battery holder disposed in the cavity. The battery holder can hold the plurality of battery cells, such that the plurality of battery cells are spaced away from an inner surface of the housing. The first battery connector can receive a first force from the first component. The second battery connector can transfer a second force, based at least in part on the first force, to the second component of the micromobility device.

The structural battery assembly can include a third battery connector configured to form a second structural connection between the housing and the first component of the micromobility device. The third battery connector can receive a third force from the first component. The structural battery assembly can include a fourth battery positioned between the first battery connector and the third battery connector. The fourth battery connector can form a third structural connection between the housing and the first component and can dampen vibrations transmitted from the first component to the housing.

At least one aspect is directed to a method. The method can include providing a housing defining a cavity. The method can include coupling the housing with a drive unit. The drive unit can receive a pushing force from a suspension assembly of a micromobility device via a first suspension connector. The drive unit can receive a pulling force from the suspension assembly via a second suspension connector. The method can include positioning a plurality of battery cells within the cavity. The method can include coupling the housing with the drive unit by a first battery connector. The first battery connector can receive a first pushing force from the drive unit. The method can include coupling the housing with a frame of the micromobility device by a second battery connector. The second battery connector can receive a second pushing force from the first battery connector induced by the first pushing force. The second pushing force can induce a compression load between the first battery connector and the second battery connector. The method can include coupling the housing with the drive unit by a third battery connector. The third battery connector can receive a pulling force from the drive unit. The pulling force can induce a tension load between the second battery connector and the third battery connector. The compression load and the tension load can produce a shear flow transmitted across the housing and around the plurality of battery cells.

The method can include positioning a plurality of intersecting ribs forming a grid structure on an exterior surface of the housing. The plurality of intersecting ribs can reinforce walls of the housing and transmit shear flow around the plurality of battery cells. The method can include positioning a battery holder within the cavity and positioning the plurality of battery cells within the battery holder, such that the plurality of battery cells are spaced away from an inner surface of the housing.

The method can include coupling the housing with the drive unit by a fourth battery connector. The method can include positioning the fourth battery connector between the first battery connector and the third battery connector. The fourth battery connector can dampen vibrations transmitted from the drive unit to the housing.

In various embodiments, the micromobility device may be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations.

The phraseology and terminology used herein are for the purpose of description and should not be regarded as limiting. The use of “including” “comprising” “having” “containing” “involving” “characterized by” “characterized in that” and variations thereof herein is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation or embodiment, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ or both ‘A’ and ‘B.’ Such references used in conjunction with “comprising” or other open terminology can include additional items.

Where technical features in the drawings, detailed descriptions, or any claims are followed by reference signs, the reference signs have been included to increase the intelligibility of the drawings, detailed descriptions, and claims. Accordingly, neither the reference signs nor their absence have any limiting effect on the scope of any claim elements.

Modifications of described elements and acts, such as variations in sizes, dimensions, structures, shapes, and proportions of the various elements, values of parameters, mounting arrangements, use of materials, colors, and orientations, can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions, and arrangement of the disclosed elements and operations without departing from the scope of the present disclosure.

Further relative parallel, perpendicular, vertical, or other positioning or orientation descriptions include variations within +/-25% or +/-25 degrees of pure vertical, parallel, or perpendicular positioning. References to “approximately,” “substantially,” or other terms of degree include variations of +/-25% from the given measurement, unit, or range unless explicitly indicated otherwise. Coupled elements can be electrically, mechanically, or physically coupled with one another directly or with intervening elements. The scope of the systems and methods described herein is thus indicated by the appended claims, rather than the foregoing description, and changes that come within the meaning and range of equivalency of the claims are embraced therein.

What is claimed is:

1. A micromobility device, comprising:
a frame;
a first wheel and a second wheel rotatably coupled with the frame;
a suspension assembly coupled with the second wheel;
a drive unit coupled with the suspension assembly by a first suspension connector and by a second suspension connector, the drive unit configured to receive a pushing force from the suspension assembly via the first suspension connector and to receive a pulling force from the suspension assembly via the second suspension connector; and
a structural battery assembly, including:
a housing defining a cavity;
a plurality of battery cells disposed in the cavity;
a first battery connector coupling the housing with the drive unit, the first battery connector configured to receive a first pushing force from the drive unit;
a second battery connector coupling the housing with the frame, the second battery connector configured to receive a second pushing force from the first battery connector induced by the first pushing force, the second pushing force inducing a compression load between the first battery connector and the second battery connector; and
a third battery connector coupling the housing with the drive unit, the third battery connector configured to receive a pulling force from the drive unit, the pulling force inducing a tension load between the second battery connector and the third battery connector, the compression load and the tension load producing a shear flow transmitted across the housing and around the plurality of battery cells.

2. The micromobility device of claim 1, comprising:
the housing including a plurality of intersecting ribs forming a grid structure on an exterior surface of the housing, the plurality of intersecting ribs being configured to reinforce walls of the housing and to transmit the shear flow around the plurality of battery cells.

3. The micromobility device of claim 1, comprising:
the drive unit including a first rib extending between the first suspension connector and the first battery connector, the first rib configured to direct at least a portion of the first pushing force from the first suspension connector to the first battery connector.

4. The micromobility device of claim 1, comprising:
the drive unit including a second rib extending between the second suspension connector and the first battery connector, the second rib configured to direct at least a portion of the pulling force from the second suspension connector to the first battery connector.

5. The micromobility device of claim 1, comprising:
the drive unit including a third rib extending between the second suspension connector and the third battery connector, the third rib configured to direct at least a portion of the pulling force from the second suspension connector to the third battery connector.

6. The micromobility device of claim 1, comprising:
the drive unit including:
a first rib extending between the first suspension connector and the first battery connector, the first rib configured to direct at least a portion of the pushing force from the first suspension connector to the first battery connector;
a second rib extending between the second suspension connector and the first battery connector, the first rib configured to direct at least a portion of the pulling force from the second suspension connector to the first battery connector; and
a third rib extending between the second suspension connector and the third battery connector, the third rib configured to direct at least a portion of the pulling force from the second suspension connector to the third battery connector.

7. The micromobility device of claim 1, comprising:
a battery holder disposed in the cavity, the battery holder configured to hold the plurality of battery cells, such that the plurality of battery cells are spaced away from an inner surface of the housing.

8. The micromobility device of claim 1, comprising:
a fourth battery connector coupling the housing with the drive unit, the fourth battery connector positioned between the first battery connector and the third battery connector and configured to dampen vibrations transmitted from the drive unit to the housing.

9. A structural battery assembly, comprising:
a housing defining a cavity, the housing including:
a first battery connector configured to form a first structural connection between the housing and a first component of a micromobility device; and
a second battery connector configured to form a structural connection between the housing and a second component of the micromobility device; and
a plurality of battery cells disposed in the cavity; and
wherein;
the first battery connector is configured to receive a first force from the first component; and
the second battery connector is configured to transfer a second force, based at least in part on the first force, to the second component of the micromobility device.

10. The structural battery assembly of claim 9, wherein the first force induces a compression load between the first battery connector and the second battery connector, the structural battery assembly comprising:
a third battery connector configured to form a second structural connection between the housing and the first component of the micromobility device, wherein the third battery connector is configured to receive a third force from the first component, the third force inducing a tension load between the second battery connector and the third battery connector,
wherein the compression load and the tension load produce a shear flow transmitted across the housing and around the plurality of battery cells.

11. The structural battery assembly of claim 9, wherein the first force induces a compression load between the first battery connector and the second battery connector, the structural battery assembly comprising:
a third battery connector configured to form a second structural connection between the housing and the first component of the micromobility device, wherein the third battery connector is configured to receive a third force from the first component, the third force inducing a tension load between the second battery connector and the third battery connector,
wherein the compression load and the tension load produce a shear flow transmitted across the housing and around the plurality of battery cells, and
wherein the housing includes a plurality of intersecting ribs forming a grid structure on an exterior surface of the housing, the plurality of intersecting ribs being configured to reinforce walls of the housing and to transmit the shear flow around the plurality of battery cells.

12. The structural battery assembly of claim 9, wherein the first component includes a first rib extending between a first suspension connector and the first battery connector, the first rib configured to direct at least a portion of the first force to the first battery connector.

13. The structural battery assembly of claim 9, wherein the first component includes a second rib extending between a second component connector and the first battery connector, the second rib configured to direct at least a portion of a fourth force to the first battery connector.

14. The structural battery assembly of claim 9, comprising:
a third battery connector configured to form a second structural connection between the housing and the first component of the micromobility device, wherein the third battery connector is configured to receive a third force from the first component;
wherein the first component includes a third rib extending between a second component connector and the third battery connector, the third rib configured to direct at least a portion of the third force to the third battery connector.

15. The structural battery assembly of claim 9, comprising:
a battery holder disposed in the cavity, the battery holder configured to hold the plurality of battery cells, such that the plurality of battery cells are spaced away from an inner surface of the housing.

16. The structural battery assembly of claim 9, comprising:
a third battery connector configured to form a second structural connection between the housing and the first component of the micromobility device, wherein the third battery connector is configured to receive a third force from the first component; and
a fourth battery positioned between the first battery connector and the third battery connector and configured form a third structural connection between the housing and the first component and to dampen vibrations transmitted from the first component to the housing.

17. A method, comprising:
providing a housing defining a cavity;
coupling the housing with a drive unit, the drive unit configured to receive a pushing force from a suspension assembly of a micromobility device via a first suspension connector and to receive a pulling force from the suspension assembly via a second suspension connector;
positioning a plurality of battery cells within the cavity;
coupling the housing with the drive unit by a first battery connector, the first battery connector configured to receive a first pushing force from the drive unit;
coupling the housing with a frame of the micromobility device by a second battery connector, the second battery connector configured to receive a second pushing force from the first battery connector induced by the first pushing force, the second pushing force inducing a compression load between the first battery connector and the second battery connector; and
coupling the housing with the drive unit by a third battery connector, the third battery connector configured to receive a pulling force from the drive unit, the pulling force inducing a tension load between the second battery connector and the third battery connector, the compression load and the tension load producing a shear flow transmitted across the housing and around the plurality of battery cells.

18. The method of claim 17, comprising:
positioning a plurality of intersecting ribs forming a grid structure on an exterior surface of the housing, the plurality of intersecting ribs being configured to reinforce walls of the housing and to transmit the shear flow around the plurality of battery cells.

19. The method of claim 17, comprising:
positioning a battery holder within the cavity; and
positioning the plurality of battery cells within the battery holder, such that the plurality of battery cells are spaced away from an inner surface of the housing.

20. The method of claim 17, comprising:
coupling the housing with the drive unit by a fourth battery connector; and
positioning the fourth battery connector between the first battery connector and the third battery connector, the fourth battery connector configured to dampen vibrations transmitted from the drive unit to the housing.
